(19) United States
(12) Patent Application Publication
(10) Pub. No.: US 2013/0034853 A1
(43) Pub. Date: Feb. 7, 2013

(54) TWO-COLOR CHROMOGENIC IN SITU HYBRIDIZATION

(71) Applicants: Brian Kelly, Tucson, AZ (US); Hiro Nitta, Oro Valley, AZ (US); Thomas Grogan, Tucson, AZ (US); Larry Morrison, Oro Valley, AZ (US)

(72) Inventors: Brian Kelly, Tucson, AZ (US); Hiro Nitta, Oro Valley, AZ (US); Thomas Grogan, Tucson, AZ (US); Larry Morrison, Oro Valley, AZ (US)

(21) Appl. No.: 13/640,301

(22) PCT Filed: Apr. 20, 2011
(86) PCT No.: PCT/US11/33176

§ 371 Date: Oct. 9, 2012

Related U.S. Application Data
(60) Provisional application No. 61/326,037, filed on Apr. 20, 2010.
(60) Provisional application No. 61/350,560, filed on Jun. 2, 2010.

(51) Int. Cl. G01N 21/76

(52) U.S. Cl. 435/6.11; 436/501

(57) ABSTRACT

The present invention relates to systems and processes for chromogenic in situ hybridization (CISH), and in particular to methods that prevent interference between two or more color detection systems in a single assay. The present invention also relates to processes for scoring assays utilizing break-apart probes.

### CROSS-REFERENCE TO RELATED APPLICATION

This invention claims the benefit of U.S. Provisional Patent Application No. 61/326,037, filed Apr. 20, 2010, and U.S. Provisional Patent Application No. 61/350,560, filed Jun. 2, 2010, the entire contents of which are incorporated herein by reference in their entireties.

### FIELD OF THE INVENTION

The present invention relates to systems and processes for chromogenic in situ hybridization (CISH), and in particular to methods which prevent interference between two or more color detection systems in a single assay, and further relates to processes for scoring assays utilizing break-apart probes.

### BACKGROUND OF THE INVENTION

Molecular cytogenetic techniques, such as chromogenic in situ hybridization (CISH) combine visual evaluation of chromosomes (karyotypic analysis) with molecular techniques. Molecular cytogenetics methods are based on hybridization of a nucleic acid probe to its complementary nucleic acid within a cell. A probe for a specific chromosomal region will recognize and hybridize to its complementary sequence on a metaphase chromosome or within an interphase nucleus (for example in a tissue sample). Probes have been developed for a variety of diagnostic and research purposes.

Sequence probes hybridize to single copy DNA sequences in a specific chromosomal region or gene. These are the probes used to identify the chromosomal critical region or gene associated with a syndrome or condition of interest. On metaphase chromosomes, such probes hybridize to each chromatid, usually giving two small, discrete signals per chromosome.

Hybridization of sequence probes, such as repeat depleted probes or unique sequence probes, has made possible detection of chromosomal abnormalities associated with numerous diseases and syndromes, including constitutive genetic anomalies, such as microdeletion syndromes, chromosome translocations, gene amplification and aneuploidy syndromes, neoplastic diseases as well as pathogen infections. Most commonly these techniques are applied to standard cytogenetic preparations on microscope slides. In addition, these procedures can be used on slides of formalin-fixed paraffin embedded tissue, blood or bone marrow smears, and directly fixed cells or other nuclear isolates.

For example, these techniques are frequently used to characterize tumor cells for both diagnosis and prognosis of cancer. Numerous chromosomal abnormalities have been associated with the development of cancer (for example, aneuploidies such as trisomy 8 associated with certain myeloid disorders; translocations such as the BCR/ABL rearrangement in chronic myelogenous leukemia; and amplifications of specific nucleic acid sequences associated with neoplastic transformation). Molecular techniques can augment standard cytogenetic testing in the detection and characterization of such acquired chromosomal anomalies.

Systems for dual color CISH have been introduced. These include the Dako DuoCISH™ system and the ZytoVision ZytoDot® 2C system. Both of these systems use separate enzymes (alkaline phosphatase and horseradish peroxidase) for the two color detection steps.

### SUMMARY OF THE INVENTION

The present invention relates to systems and processes for chromogenic in situ hybridization (CISH), and in particular to methods which prevent interference between two or more color detection systems in a single assay, and further relates to processes for scoring assays utilizing break-apart probes.

In some embodiments, the present invention provides processes for detection of nucleic acids in a sample comprising: hybridizing at least first and second nucleic acid probes to first and second target nucleic acids in the sample; contacting the sample with first chromogenic detection reagents specific for the first nucleic acid probe comprising an enzyme and a first chromogenic substrate system, wherein the contacting is under conditions such that the enzyme acts on the first chromogenic substrate system to produce a detectable first chromogen; denaturing the enzyme; contacting the sample with second chromogenic detection reagents specific for the second nucleic acid probe comprising an enzyme and a second chromogenic substrate system, wherein the contacting is under conditions such that the enzyme acts on the second chromogenic substrate system to produce a detectable second chromogen; and detecting the first and second detectable chromogens. In some embodiments, the denaturing further comprising treating the sample with a solution comprising a denaturing agent. In some embodiments, the denaturing agent is selected from the group consisting of formamide, an alkyl-substituted amide, urea or a urea-based denaturant, thiourea, guanidine hydrochloride, and derivatives thereof. In some embodiments, the denaturing agent is formamide.

In some embodiments, the first nucleic acid probe comprises a first hapten and the second nucleic acid probe comprises a second hapten. In some embodiments, the first hapten is one of DIG and DNP and the second hapten is the other of DIG and DNP. In some embodiments, the first and second chromogenic substrate systems are selected from the group consisting of systems comprising diaminobenzidine (DAB), 4-nitrophenylphospate (pNPP), naphthol phosphate/Fast Red (and variations thereof such as Fast Red KL/Naphthol AS-TR, naphthol phosphate/fuschin, naphthol phosphate/Fast Blue BB (4-(benzoylamino)-2,5-diethoxybenzenediazotetrachlorozincate), bromochloroindolyl phosphate (BCIP)/naphthol phosphate, BCIP/NBT, BCIP/INT, tetramethylbenzidine (TMB), 2,2′-azino-di-[3-ethylbenzothiazoline sulphonate] (ABTS), o-dianisidine, 4-chloronaphthol (4-CN), nitrophenyl-β-D-galactopyranoside (ONPG), o-phenylenediamine (OPD), 5-bromo-4-chloro-3-indolyl-β-galactopyranoside (X-Gal), methylumbelliferyl-β-D-galactopyranoside (MU-Gal), p-nitrophenyl-α-D-galactopyranoside (PNP), 5-bromo-4-chloro-3-indolyl-β-D-glucuronide (X-Gluc), and 3-amino-9-ethyl carbazol (AEC). In some embodiments,the first chromogenic substrate system is one of Fast Blue BB or naphthol phosphate/Fast Red and the second chromogenic substrate system is selected from the other of Fast Blue BB/naphthol phosphate and naphthol phosphate/Fast Red.

In some embodiments, the sample comprises cells. In some embodiments, the cells are fixed on a slide. In some embodiments, the cells are a tissue. In some embodiments, the first and second detectable chromogens are detected by bright field microscopy.

In some embodiments, the first chromogenic detection reagents specific for the first nucleic acid probe further comprise a first antibody specific for the first hapten and a second antibody specific for the first antibody, wherein the second antibody is conjugated to an enzyme. In some embodiments, the enzyme is selected from the group consisting of horseradish peroxidase, alkaline phosphatase, acid phosphatase, glucose oxidase, β-galactosidase, β-glucuronidase and β-lactamase. In some embodiments, the second chromogenic detection reagents specific for the second nucleic acid probe further comprise a first antibody specific for the second hapten and a second antibody specific for the first antibody, wherein the second antibody is conjugated to an enzyme. In some embodiments, the enzyme is selected from the group consisting of, horseradish peroxidase, alkaline phosphatase, acid phosphatase, glucose oxidase, β-galactosidase, β-glucuronidase and β-lactamase. In some embodiments, the enzyme in the first and second chromogenic detection reagents is the same enzyme. In some embodiments, the enzyme is alkaline phosphatase. In some embodiments, the first chromogenic detection reagents specific for the first nucleic acid probe further comprise a first antibody specific for the first hapten and conjugated to an enzyme and a second antibody specific for the second hapten and conjugated to an enzyme. In some embodiments, the enzyme is selected from the group consisting of, horseradish peroxidase, alkaline phosphatase, acid phosphatase, glucose oxidase, β-galactosidase, β-glucuronidase and β-lactamase.

In some embodiments, the hybridizing and contacting steps are automated.

In some embodiments, the present invention provides kits comprising: first chromogenic detection reagents specific for a first nucleic acid probe comprising an enzyme and a first chromogenic substrate system; second chromogenic detection reagents specific for a second nucleic acid probe comprising an enzyme and a second chromogenic substrate system; and a denaturation reagent.

In some embodiments, the present invention provides process for diagnosing a cancer in a patient, providing a prognosis for a patient with cancer, predicting the likelihood of recurrence of a cancer in a patient, predicting the predisposition of a patient to a cancer, or an indication that a patient is a candidate from treatment with a therapy, wherein the cancer is associated with an ALK gene rearrangement, comprising: hybridizing 5′ and 3′ ALK break-apart probes to a patient sample; detecting signals associated with hybridization the 5′ and 3′ ALK break-apart probes; scoring any signal other than a fused, non-rearranged signal as an abnormal signal; and using the score to diagnose a cancer in the patient, provide a prognosis for the patient, predict the likelihood of recurrence of a cancer in the patient, predict the predisposition of the patient to a cancer, or indicate that the patient is a candidate for a particular therapy. In some embodiments, the cancer is non-small-cell lung cancer. In some embodiments, the 5′ and 3′ ALK break-apart probes are probe sets that hybridize either 5′ or 3′ to a breakpoint associated with ALK rearrangement. In some embodiments, the 5′ and 3′ ALK break-apart probes are detected by chromogenic detection with different chromogens for the 5′ and 3′ ALK break-apart probes. In some embodiments, the chromogenic detection comprises detection of the 5′ and 3′ ALK break-apart probes with first and second chromogenic detection reagents specific for the 5′ and 3′ ALK break-apart probes, respectively. In some embodiments, the first chromogenic detection reagents specific for the 5′ ALK break-apart probe comprise an enzyme and a first chromogenic substrate system and the second chromogenic detection reagents specific for the 5′ ALK break-apart probe comprising an enzyme and a second chromogenic substrate system.

In some embodiments, the chromogenic detection comprises: contacting the sample with the first chromogenic detection reagents under conditions such that the enzyme acts on the first chromogenic substrate system to produce a detectable first chromogen; denaturing the enzyme; and contacting the sample with second chromogenic detection reagents under conditions such that the enzyme acts on the second chromogenic substrate system to produce a detectable second chromogen. In some embodiments, the denaturing further comprising treating the sample with a solution comprising a denaturing agent. In some embodiments, the denaturing agent is selected from the group consisting of formamide, an alkyl-substituted amide, urea or a urea-based denaturant, thiourea, guanidine hydrochloride, and derivatives thereof. In some embodiments, the denaturing agent is formamide. In some embodiments, the enzyme is alkaline phosphatase. In some embodiments, the substrate is an alkaline phosphatase substrate. In some embodiments, the alkaline phosphatase substrate is a system selected from the group consisting of naphthol phosphate/Fast Red (and variations thereof such as Fast Red KL/Naphthol AS-TR), naphthol phosphate/fuschin, naphthol phosphate/Fast Blue BB (4-(benzoylamino)-2,5-diethoxybenzenediazotetrachlorozincate), 5-bromo,4-chloro, 3-indolyl phosphate (BCIP)/naphthol phosphate, BCIP/nitroblue tetrazolium (NBT), and BCIP/p-Iodonitrotetrazolium (INT). In some embodiments, the 5′ and 3′ ALK break-apart probes are detected by fluorescent detection. In some embodiments, at least one of the 5′ and 3′ ALK break-apart probes are detected by silver in situ hybridization. In some embodiments, one of the 5′ and 3′ ALK break-apart probes is detected by silver in situ hybridization and the other of the 5′ and 3′ ALK break-apart probes is detected by chromogenic in situ hybridization.

In some embodiments, the scoring further comprises applying a cut-off range selected from the group consisting of from about 15% to 75%, 20% to 60%, 25% to 45% and 27% to 38% of cells with an abnormal signal in the sample, wherein samples within the cut-off range are correlated to a diagnosis of cancer in the patient, a good or poor prognosis for the patient, a prediction of likelihood of recurrence of a cancer in the patient, a prediction of the predisposition of the patient to a cancer, or an indication that the patient is a candidate for a particular therapy. In some embodiments, the process has a sensitivity and/or specificity selected from the group consisting of greater than 90%, greater than 95%, greater than 99% and 100%, when the cut-off range is applied. In some embodiments, the Distance From Ideal value for the cut-off range is selected from the group consisting of ≦0.2, ≦0.1, and 0.

In some embodiments, the processes further comprise providing a prognosis for the patient based upon whether or not the sample is positive or negative for ALK rearrangement based on the scoring. In some embodiments, the processes further comprise providing a diagnosis for the patient based upon whether or not the sample is positive or negative for ALK rearrangement based on the scoring. In some embodiments, the processes further comprise providing a prediction of likelihood of recurrence for the patient based upon whether or not the sample is positive or negative for ALK rearrangement based on the scoring. In some embodiments, the processes further comprise providing a prediction of predisposition of the patient to a cancer based upon whether or not the sample is positive or negative for ALK rearrangement based on the scoring. In some embodiments, the processes further comprise providing a particular therapy to the patient based upon whether or not the sample is positive or negative for ALK rearrangement based on the scoring. In some embodiments, the processes further comprise a cut-off of from about 10% to about 40% of cells with an abnormal signal in the sample, wherein samples exceeding the cut-off are correlated to a diagnosis of cancer in the patient, a good or poor prognosis for the patient, a prediction of likelihood of recurrence of a cancer in the patient, a prediction of the predisposition of the patient to a cancer, or an indication that the patient is a candidate for a particular therapy.

### BRIEF DESCRIPTION OF THE DRAWINGS

FIG. 1. Brightfield break-apart in situ hybridization signal detection scheme using 2 alkaline phosphatase (AP) detections. A set of digoxigenin (DIG)-labeled nick-translated probe and 2,4 dinitrophenyl (DNP)-labeled nick-translated probe were co-hybridized (Step 1). First, DIG labeled probe signal was visualized with alkaline phosphatase (AP)-based blue detection (Step 2). Then, the AP enzyme was blocked with a hybridization buffer (Step 3). 2,4 dinitrophenyl (DNP) probe signal was visualized with AP-based red detection (Step 4). Finally, tissue sections were counterstained with Hematoxylin.

FIG. 2. Representative target detection in a tissue sample using brightfield break-apart in situ hybridization two color detection without blocking between the two color detection systems.

FIG. 3. Representative effect of the blocking step on AP-based dual color in situ hybridization signal.

FIG. 4. Design of an ALK probe set for brightfield break-apart in situ hybridization. Two repeat free ALK probes were generated for targeting the neighboring centromeric region (5′ probe, 770 kb) and telomeric region (3′ probe, 683 kb) of the ALK gene. The 5′ ALK probe was labeled with digoxigenin (DIG) while the 3′ probe was labeled with 2,4 dinitrophenyl (DNP).

FIG. 5. Design of an MALT1 probe set for brightfield break-apart in situ hybridization. Two repeat free MALT1 probes were generated for targeting the neighboring centromeric region (5′ probe, 499 kb) and telomeric region (3′ probe, 693 kb) of the MALT1 gene. The 5′ MALT1 probe was labeled with digoxigenin (DIG) while the 3′ probe was labeled with 2,4 dinitrophenyl (DNP).

FIG. 6. Dual color fluorescence in situ hybridization (FISH) for ALK probes with the chromosome 2 centromere probe and MALT1 probes with the chromosome 18 centromere probe on comparative genomic hybridization metaphase control slide. 5′ ALK FISH signal (green) was detected on the same chromosome that was labeled with the chromosome 2 centromere probe (red) (A). 3′ ALK FISH signal (green) was detected on chromosome 2 identified with the chromosome 2 centromere probe (red) (B). 5′ MALT1 FISH signal (green) was co-detected with the chromosome 18 centromere probe (red) on the same chromosome (C). 3′ MALT1 FISH signal (green) was also co-detected with the chromosome 18 centromere signal (red) on chromosome 18 (D). 100×

FIG. 7. Brightfield break-apart in situ hybridization (ba-ISH) assay optimization for ALK and MALT1 genes. Formalin-fixed, paraffin-embedded tonsils were utilized for optimizing ba-ISH applications. Hybridization of digoxigenin (DIG)-labeled 5′ ALK probe (A) and 2,4 dinitrophenyl (DNP)-labeled 3′ ALK probe (B) was detected with alkaline phosphatase (AP)-based blue detection and red detection, respectively. When both blue and red detections for ALK gene were performed purple color dots were created (C). DIG-labeled 3′ MALT1 probe (D) and DNP-labeled 5′ MALT1 probe (E) were detected with AP blue detection and AP red detection, respectively. Co-detection of 5′ and 3′ MALT1 probes was recognized as purple dots (F). Co-localization of ALK probes produced slight separation of blue and red dots (C) while MALT 1 probes results in solid purple dots (F).100×

FIG. 8. Brightfield ALK and MALT1 break-apart in situ hybridization (ba-ISH) on archived clinical cases. Non-tumor cells of anaplastic large cell lymphoma (ALCL) sample showed co-localized 5′ and 3′ ALK probe signals (A) and tumor cells were indicated with yellow asterisk marks. Lightly counterstained tumor cells demonstrated the breakage of ALK gene that was recognized as blue and red dots (blue and red arrowheads) (B). Normal MALT1 gene was observed as co-localization of 5′ and 3′ MALT1 probes with mucosa-associated lymphoma tissue (MALT) lymphoma cases (C). Breakage of MALT1 gene was observed as isolated blue and red dots (blue and red arrowheads) with MALT lymphoma cases (D). 100×

FIGS. 9A-D. Comparison of dual color ba-ISH using blue detection then red detection (A and B) and red detection then blue detection (C and D). A549 is a lung cancer cell line xenograft with wildtype ALK gene. NCI-H2228 is a lung cancer cell line xenograft with rearranged ALK gene. FIG. 10. Plot of Receiver Operator Characteristics (ROC) curves for comparisons of ISH parameters for dual CISH (single reader, one replicate for specimen).

FIG. 11. Plot of DFI vs. cutoff comparisons of ISH parameters for dual CISH (single reader, one replicate per specimen).

### DESCRIPTION OF THE INVENTION

The present invention relates to systems and processes for chromogenic in situ hybridization (CISH), and in particular to methods which prevent interference between two or more color detection systems in a single assay, and further relates to processes for scoring assays utilizing break-apart probes. In situ hybridization involves contacting a sample containing a target nucleic acid sequence (e.g., genomic target nucleic acid sequence) in the context of a metaphase or interphase chromosome preparation (such as a cell or tissue sample mounted on a slide) with a probe (i.e., the target nucleic acid probe described above) specifically hybridizable or specific for the target nucleic acid sequence (e.g., genomic target nucleic acid sequence). The slides are optionally pretreated, e.g., to remove paraffin or other materials present in formalin-fixed paraffin embedded tissues that can interfere with uniform hybridization. The chromosome sample and the probe are both treated, for example by heating to denature the double stranded nucleic acids. The probe (formulated in a suitable hybridization buffer) and the sample are combined, under conditions and for sufficient time to permit hybridization to occur (typically to reach equilibrium). The chromosome preparation is washed to remove excess target nucleic acid probe, and detection of specific labeling of the chromosome target is performed. For a general description of in situ hybridization procedures, see, e.g., U.S. Pat. No. 4,888,278. Numerous procedures for fluorescence in situ hybridization (FISH), chromogenic in situ hybridization (CISH) and silver in situ hybridization (SISH) are known in the art. For example, procedures for performing FISH are described in U.S. Pat. Nos. 5,447,841, 5,472,842, 5,427,932, and for example, in Pinkel et al., Proc. Natl. Acad. Sci. 83:2934-2938, 1986; Pinkel et al., Proc. Natl. Acad. Sci. 85:9138-9142, 1988, and Lichter et al., Proc. Natl. Acad. Sci. 85:9664-9668, 1988. CISH is described in, e.g., Tanner et al., Am. J. Pathol. 157:1467-1472, 2000, and U.S. Pat. No. 6,942,970. Additional detection methods are provided in U.S. Pat. No. 6,280,929. Exemplary procedures for detecting viruses by in situ hybridization can be found in Poddighe et al., J. Clin. Pathol. 49:M340-M344, 1996.

In some embodiments, the processes of the present invention comprise hybridizing at least first and second nucleic acid probes to first and second target nucleic acids in said sample. The sample is then contacted with first chromogenic detection reagents specific for the first nucleic acid probe. The chromogenic detection reagents preferably comprise an enzyme and a first chromogenic substrate. This step is performed under conditions suitable for the enzyme to act on the first chromogenic substrate to produce a detectable first chromogen. In some embodiments, the first and second chromogenic detection reagents comprise reagents for direct detection. In some preferred direct detection embodiments, the nucleic acid probes are preferably labeled with a hapten. In these embodiments, the reagents comprise an antihapten antibody conjugated to an enzyme and chromogenic substrate(s) for the enzyme as described in more detail below. In some embodiments, the first and second chromogenic detection reagents comprise reagents for indirect detection. In some preferred direct detection embodiments, the nucleic acid probes are preferably labeled with a hapten. In these embodiments, the reagents comprise a primary antihapten antibody and a secondary antispecies antibody (e.g., anti-mouse, anti-rabbit, anti-goat, anti-human antibodies as appropriate) conjugated to an enzyme and chromogenic substrate(s) for the enzyme as described in more detail below.

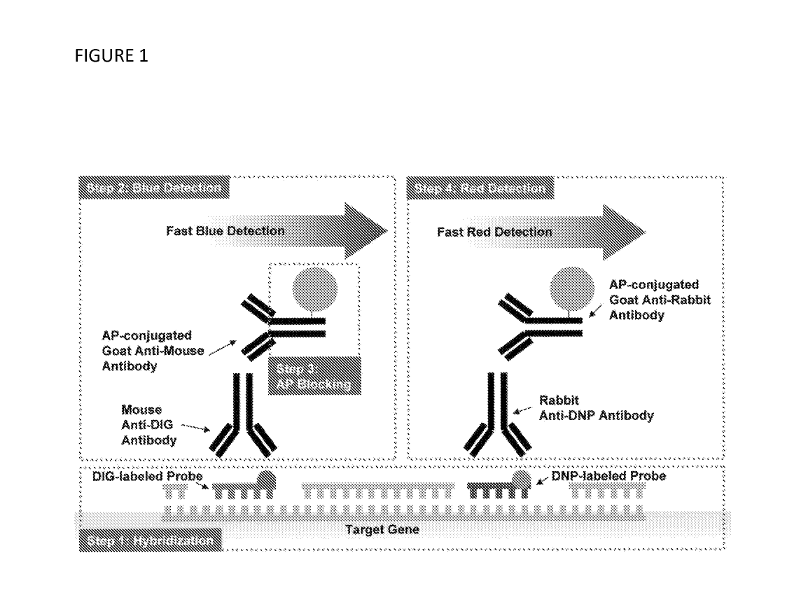

In some preferred embodiments, the enzyme is denatured following the application of the first chromogenic detection reagents specific for the first nucleic acid probe. The sample is then contacted with second chromogenic detection reagents specific for the second nucleic acid probe. The chromogenic detection reagents preferably comprise an enzyme and a second chromogenic substrate. This step is performed under conditions suitable for the enzyme to act on the second chromogenic substrate to produce a detectable second chromogen. The first and second chromogens are then detected, for example, by bright field microscopy. In some embodiments, the enzyme in the first and second chromogenic detection reagents is the same enzyme, for example, alkaline phosphatase. A schematic depiction of an exemplary process of the present invention (and exemplary reagents) is provided in FIG. 1. This system is useful for any CISH systems where detection of more than one target is desired. The order of color detection is reversible, e.g., red detection can be conducted before blue detection and vice versa. In some embodiments, the system is used with break apart probe sets. When a target gene has broken apart (e.g., due to a translocation), discrete color signals (e.g., red and blue) are visualized, whereas if the probes co-localize (i.e., no translocation) then a combination of the colors (e.g., purple) is visualized.

The denaturation step prevents the enzyme used in the first set of chromogenic detection reagents from acting on the second chromogenic substrate. This in turn improves visualization and detection of the two different colored chromogens. In some preferred embodiments, the denaturant is a substance that denatures the enzyme in the first chromogenic detection reagent set. In some embodiments, the denaturant is, for example, formamide, an alkyl-substituted amide, urea or a urea-based denaturant, thiourea, guanidine hydrochloride, or derivatives thereof. Examples of alkyl-substituted amides include, but are not limited to, N-propylformamide, N-butylformamide, N-isobutylformamide, and N,N-dipropylaformamide. In some embodiments, the denaturant is provided in a buffer. For example, formamide may be provided in a hybridization buffer comprising 20 mM dextran sulfate (50-57% % formamide (UltraPure formamide stock), 2×SSC (20×SSC stock containing 0.3 M citrate and 3M NaCl), 2.5mM EDTA (0.5M EDTA stock), 5 mM Tris, pH 7.4 (1 mM Tris, pH 7.4 stock), 0.05% Brij-35 (10% stock containing polyoxyethylene (23) lauryl ether), pH 7.4. In preferred embodiments, the sample is treated with the denaturant for a period of time and under conditions sufficient to denature the first target probe detection enzyme, for example alkaline phosphatase. In some embodiments, the sample is treated with the denaturant for about 15 to about 30 minutes, preferably about 20 to 24 minutes at about 37° C. In some embodiments, the sample is treated with the denaturant for a period of time and under conditions sufficient to denature the target enzyme while preserving hybridization of the second nucleic acid probe to the target.

Additional reagents and systems for performing the methods and processes of the present invention are described in more detail below

1. Nucleic Acid Probes

The present invention utilizes nucleic acid probes which hybridize to one or more target nucleic acid sequences. The nucleic acid probe preferably hybridizes to a target nucleic acid sequence under conditions suitable for hybridization, such as conditions suitable for in situ hybridization, Southern blotting, or Northern blotting. Preferably, the detection probe portion comprises any suitable nucleic acid, such as RNA, DNA, LNA, PNA or combinations thereof, and can comprise both standard nucleotides such as ribonucleotides and deoxyribonucleotides, as well as nucleotide analogs. LNA and PNA are two examples of nucleic acid analogs that form hybridization complexes that are more stable (i.e., have an increased Tₘ) than those formed between DNA and DNA or DNA and RNA. LNA and PNA analogs can be combined with traditional DNA and RNA nucleosides during chemical synthesis to provide hybrid nucleic acid molecules than can be used as probes. Use of the LNA and PNA analogs allows modification of hybridization parameters such as the Tₘ of the hybridization complex. This allows the design of detection probes that hybridize to the detection target sequences of the target nucleic acid probes under conditions that are the same or similar to the conditions required for hybridization of the target probe portion to the target nucleic acid sequence.

Suitable nucleic acid probes can be selected manually, or with the assistance of a computer implemented algorithm that optimizes probe selection based on desired parameters, such as temperature, length, GC content, etc. Numerous computer implemented algorithms or programs for use via the internet or on a personal computer are available. For example, to generate multiple binding regions from a target nucleic acid sequence (e.g., genomic target nucleic acid sequence), regions of sequence devoid of repetitive (or other undesirable, e.g., background-producing) nucleic acid sequence are identified, for example manually or by using a computer algorithm, such as RepeatMasker. Methods of creating repeat depleted and uniquely specific probes are found in, for example, US Patent Application publication numbers 2001/0051342 and 2008/0057513 and U.S. patent Ser. Nos. 61/291,750 and 61/314,654. Within a target nucleic acid sequence (e.g., genomic target nucleic acid sequence) that spans several to several-hundred kilobases, typically numerous binding regions that are substantially or preferably completely free of repetitive (or other undesirable, e.g., background-producing) nucleic acid sequences are identified.

In some embodiments, a hapten is incorporated into the nucleic acid probe, for example, by use of a haptenylated nucleoside. Methods for conjugating haptens and other labels to dNTPs (e.g., to facilitate incorporation into labeled probes) are well known in the art. For examples of procedures, see, e.g., U.S. Pat. Nos. 5,258,507, 4,772,691, 5,328,824, and 4,711,955. Indeed, numerous labeled dNTPs are available commercially, for example from Invitrogen Detection Technologies (Molecular Probes, Eugene, Oreg.). A label can be directly or indirectly attached of a dNTP at any location on the dNTP, such as a phosphate (e.g., α, β or γ phosphate) or a sugar. The probes can be synthesized by any suitable, known nucleic acid synthesis method. In some embodiments, the detection probes are chemically synthesized using phosphoramidite nucleosides and/or phosphoramidite nucleoside analogs. For example, in some embodiments, the probes are synthesized by using standard RNA or DNA phosphoramidite nucleosides. In some embodiments, the probes are synthesized using either LNA phosphoramidites or PNA phosphoramidites, alone or in combination with standard phosphoramidite nucleosides. In some embodiments, haptens are introduced on abasic phosphoramidites containing the desired detectable moieties. Other methods can also be used for detection probe synthesis. For example, a primer made from LNA analogs or a combination of LNA analogs and standard nucleotides can be used for transcription of the remainder of the probe. As another example, a primer comprising detectable moieties is utilized for transcription of the rest of the probe. In still other embodiments, segments of the probe produced, for example, by transcription or chemical synthesis, may be joined by enzymatic or chemical ligation.

A variety of haptens may be used in the detectable moiety portion of the detection probe. Such haptens include, but are not limited to, pyrazoles, particularly nitropyrazoles; nitrophenyl compounds; benzofurazans; triterpenes; ureas and thioureas, particularly phenyl ureas, and even more particularly phenyl thioureas; rotenone and rotenone derivatives, also referred to herein as rotenoids; oxazole and thiazoles, particularly oxazole and thiazole sulfonamides; coumarin and coumarin derivatives; cyclolignans, exemplified by Podophyllotoxin and Podophyllotoxin derivatives; and combinations thereof. Specific examples of haptens include, but are not limited to, 2,4-Dintropheyl (DNP), Biotin, Fluorescein derivatives (FITC, TAMRA, Texas Red, etc.), Digoxygenin (DIG), 5-Nitro-3-pyrozolecarbamide (nitropyrazole, NP), 4,5,-Dimethoxy-2-nitrocinnamide (nitrocinnamide, NCA), 2-(3,4-Dimethoxyphenyl)-quinoline-4-carbamide (phenylquinolone, DPQ), 2,1,3-Benzoxadiazole-5-carbamide (benzofurazan, BF), 3-Hydroxy-2-quinoxalinecarbamide (hydroxyquinoxaline, HQ), 4-(Dimethylamino)azobenzene-4′-sulfonamide (DABSYL), Rotenone isoxazoline (Rot), (E)-2-(2-(2-oxo-2,3-dihydro-1H-benzo[b][1,4]diazepin-4-yl)phenozy)acetamide (benzodiazepine, BD), 7-(diethylamino)-2-oxo-2H-chromene-3-carboxylic acid (coumarin 343, CDO), 2-Acetamido-4-methyl-5-thiazolesulfonamide (thiazolesulfonamide, TS), and p-Mehtoxyphenylpyrazopodophyllamide (Podo). These haptens and their use in probes are described in more detail in co-owned applications US Pat. Publ. Nos. 20080305497, 20080268462, and 20080057513, incorporated herein by reference in their entirety.

### 2. Chromogenic Detection Reagents

The processes of the present invention utilize chromogenic detection reagents. Chromogenic detection reagents comprise an enzyme and a chromogenic substrate for the enzyme. The enzyme acts on the chromogenic substrate to produce a colored, detectable signal. Examples of suitable enzymes include, but are not limited to, horseradish peroxidase, alkaline phosphatase, acid phosphatase, glucose oxidase, β-galactosidase, β-glucuronidase or β-lactamase. Particular examples of enzyme substrates and enzyme substrate systems useful in chromogenic detection assays include, but are not limited to, diaminobenzidine (DAB), 4-nitrophenylphospate (pNPP), naphthol phosphate, naphthol phosphate/Fast Red (e.g., 4-Chloro-2-methylbenzenediazonium salt and variations thereof such as Fast Red KL/Naphthol AS-TR, naphthol phosphate/fuschin, Fast Blue BB (4-(benzoylamino)-2,5-diethoxybenzenediazotetrachlorozincate)/naphthol phosphate (e.g. naphthol AS-TR phosphate (N-4-Chloro-2-methylphenyl)-3-(phosphonooxy) naphthalene-2-carboxamide), bromochloroindolyl phosphate (BCIP), BCIP/NBT (nitroblue tetrazolium), BCIP/INT (p-Iodonitrotetrazolium), tetramethylbenzidine (TMB), 2,2′-azino-di-[3-ethylbenzothiazoline sulphonate] (ABTS), o-dianisidine, 4-chloronaphthol (4-CN), nitrophenyl-β-D-galactopyranoside (ONPG), o-phenylenediamine (OPD), 5-bromo-4-chloro-3-indolyl-β-galactopyranoside (X-Gal), methylumbelliferyl-β-D-galactopyranoside (MU-Gal), p-nitrophenyl-α-D-galactopyranoside (PNP), 5-bromo-4-chloro-3-indolyl-β-D-glucuronide (X-Gluc), and 3-amino-9-ethyl carbazol (AEC). In some preferred embodiments where the enzyme is alkaline phosphatase, the chromogenic substrate system is selected from the group consisting of naphthol phosphate/Fast Red (and variations thereof such as Fast Red KL/Naphthol AS-TR), naphthol phosphate/fuschin, naphthol phosphate/Fast Blue BB (4-(benzoylamino)-2,5-diethoxybenzenediazotetrachlorozincate), 5-bromo,4-chloro,3-indolyl phosphate (BCIP)/naphthol phosphate, BCIP/nitroblue tetrazolium (NBT), and BCIP/p-Iodonitrotetrazolium (INT). Other suitable alkaline phosphatase substrate are known in the art, including, but not limited to, WarpRed™, Vulcan Fast Red, Ferangi Blue, and Vector® Blue, Black and Red. In particularly preferred embodiments, Fast Blue BB is utilized in a chromogenic blue detection system. In particularly preferred embodiments, naphthol phosphate with a diazonium salt are utilized in a chromogenic red detection system. In the most preferred embodiments, Fast Blue BB and naphthol phosphate/Fast red chromogenic detection systems are utilized on the same tissue, thereby providing a dual chromogenic assay that detections two target molecules in a tissue sample.

In some embodiments, the enzyme is conjugated to an anti-hapten antibody. In these embodiments, the anti-hapten antibody binds to the haptenylated nucleic acid probe. In other embodiments, additional antibodies are used. For example, in some embodiments, the first antibody is a rabbit, mouse or goat anti-hapten antibody and the second antibody is an enzyme-conjugated anti-rabbit, anti-mouse, or anti-goat antibody, respectively. Examples of suitable linker and attachment chemistries are described in U.S. Patent Application Publication Nos. 2006/0246524; 2006/0246523, and U.S. Provisional Patent Application No. 60/739,794.

The present invention is not limited to the use of antibodies. Any suitable antigen binding proteins may be utilized. Examples of suitable antigen binding molecules include, but are not limited to, antibodies, immunoglobulins or immunoglobulin-like molecules (including by way of example and without limitation, IgA, IgD, IgE, IgG and IgM), antibody fragments such as F(ab′)₂ fragments, Fab′ fragments, Fab′-SH fragments and Fab fragments as are known in the art, recombinant antibody fragments (such as sFv fragments, dsFv fragments, bispecific sFv fragments, bispecific dsFv fragments, F(ab)′₂ fragments, single chain Fv proteins (“scFv”), disulfide stabilized Fv proteins (“dsFv”), diabodies, and triabodies (as are known in the art), and camelid antibodies (see, for example, U.S. Pat. Nos. 6,015,695; 6,005,079-5,874,541; 5,840,526; 5,800,988; and 5,759,808).

3. Targets

A target nucleic acid molecule can be any selected nucleic acid, such as DNA or RNA. In some embodiments the target nucleic acid is detected in a cell fixed on a slide. In some embodiments, the target nucleic acid is detected in a tissue fixed on a slide.

In particular embodiments, the target sequence is a genomic target sequence or genomic subsequence, for example from a eukaryotic genome, such as a human genome. In some embodiments, the target nucleic acid is cytoplasmic RNA. In some embodiments, the target nucleic acid molecule is selected from a pathogen, such as a virus, bacteria, or intracellular parasite, such as from a viral genome. In some embodiments, the target nucleic acid sequence is a genomic sequence, such as eukaryotic (e.g., mammalian) or viral genomic sequence. Target nucleic acid probes can be generated which correspond to essentially any genomic target sequence that includes at least a portion of unique non-repetitive DNA. For example, the genomic target sequence can be a portion of a eukaryotic genome, such as a mammalian (e.g., human), fungal or intracellular parasite genome. Alternatively, a genomic target sequence can be a viral or prokaryotic genome (such as a bacterial genome), or portion thereof. In a specific example, the genomic target sequence is associated with an infectious organism (e.g., virus, bacteria, fungi).

In some embodiments, the target nucleic acid molecule can be a sequence associated with (e.g., correlated with, causally implicated in, etc.) a disease. In some embodiments, a target sequence is selected that is associated with a disease or condition, such that detection of hybridization can be used to infer information (such as diagnostic or prognostic information for the subject from whom the sample is obtained) relating to the disease or condition. In certain embodiments, the selected target nucleic acid molecule is a target nucleic acid molecule associated with a neoplastic disease (or cancer). In some embodiments, the genomic target sequence can include at least one at least one gene associated with cancer (e.g., HER2, c-Myc, n-Myc, Abl, Bcl2, Bcl6, R1, p53, EGFR, TOP2A, MET, or genes encoding other receptors and/or signaling molecules, etc.) or chromosomal region associated with a cancer. In some embodiments, the target nucleic acid sequence can be associated with a chromosomal structural abnormality, e.g., a translocation, deletion, or reduplication (e.g., gene amplification or polysomy) that has been correlated with a cancer. In some embodiments, the target nucleic acid sequence encompasses a genomic sequence that is reduplicated or deleted in at least some neoplastic cells. The target nucleic acid sequence can vary substantially in size, such as at least 20 base pairs in length, at least 100 base pairs in length, at least 1000 base pairs in length, at least 50,000, at least 100,000, or even at least 250,000 base pairs in overall length.

The target nucleic acid sequence (e.g., genomic target nucleic acid sequence) can span any number of base pairs. In some embodiments, the target nucleic acid sequence spans at least 1000 base pairs. In specific examples, a target nucleic acid sequence (e.g., genomic target nucleic acid sequence) is at least 10,000, at least 50,000, at least 100,000, at least 150,000, at least 250,000, or at least 500,000 base pairs in length (such as 100 kb to 600 kb, 200 kb to 500 kb, or 300 kb to 500 kb). In examples, where the target nucleic acid sequence is from a eukaryotic genome (such as a mammalian genome, e.g., a human genome), the target sequence typically represents a small portion of the genome (or a small portion of a single chromosome) of the organism (for example, less than 20%, less than 10%, less than 5%, less than 2%, or less than 1% of the genomic DNA (or a single chromosome) of the organism). In some examples where the target sequence (e.g., genomic target nucleic acid sequence) is from an infectious organism (such as a virus), the target sequence can represent a larger proportion (for example, 50% or more) or even all of the genome of the infectious organism.

In specific non-limiting examples, a target nucleic acid sequence (e.g., genomic target nucleic acid sequence) associated with a neoplasm (for example, a cancer) is selected. Numerous chromosome abnormalities (including translocations and other rearrangements, reduplication or deletion) have been identified in neoplastic cells, especially in cancer cells, such as B cell and T cell leukemias, lymphomas, breast cancer, colon cancer, gastric cancer, esophageal cancer, neurological cancers and the like. Therefore, in some examples, at least a portion of the target nucleic acid sequence (e.g., genomic target nucleic acid sequence) is reduplicated or deleted in at least a subset of cells in a sample.

Translocations involving oncogenes are known for several human malignancies. For example, chromosomal rearrangements involving the SYT gene located in the breakpoint region of chromosome 18q11.2 are common among synovial sarcoma soft tissue tumors. The t(18q11.2) translocation can be identified, for example, using probes with different labels: the first probe includes nucleic acid molecules generated from a target nucleic acid sequence that extends distally from the SYT gene, and the second probe includes nucleic acid generated from a target nucleic acid sequence that extends 3′ or proximal to the SYT gene. When probes corresponding to these target nucleic acid sequences (e.g., genomic target nucleic acid sequences) are used in an in situ hybridization procedure, normal cells, which lacks a t(18q11.2) in the SYT gene region, exhibit two fusion (generated by the two labels in close proximity) signals, reflecting the two intact copies of SYT. Abnormal cells with a t(18q11.2) exhibit a single fusion signal.

Numerous examples of reduplication of genes involved in neoplastic transformation have been observed, and can be detected cytogenetically by in situ hybridization using the disclosed probes. In one example, the target nucleic acid sequence (e.g., genomic target nucleic acid sequence) is selected include a gene (e.g., an oncogene) that is reduplicated in one or more malignancies (e.g., a human malignancy). For example, HER2, also known as c-erbB2 or HER2/neu, is a gene that plays a role in the regulation of cell growth (a representative human HER2 genomic sequence is provided at GENBANK™ Accession No. NC_{—}000017, nucleotides 35097919-35138441). The gene codes for a 185 kd transmembrane cell surface receptor that is a member of the tyrosine kinase family. HER2 is amplified in human breast, ovarian, gastric and other cancers. Therefore, a HER2 gene (or a region of chromosome 17 that includes the HER2 gene) can be used as a genomic target nucleic acid sequence to generate probes that include nucleic acid molecules with binding regions specific for HER2.

In other examples, a target nucleic acid sequence (e.g., genomic target nucleic acid sequence) is selected that is a tumor suppressor gene that is deleted (lost) in malignant cells. For example, the p16 region (including D9S1749, D9S1747, p16(INK4A), p14(ARF), D9S1748, p15(INK4B), and D9S1752) located on chromosome 9p21 is deleted in certain bladder cancers. Chromosomal deletions involving the distal region of the short arm of chromosome 1 (that encompasses, for example, SHGC57243, TP73, EGFL3, ABL2, ANGPTL1, and SHGC-1322), and the pericentromeric region (e.g., 19p13-19q13) of chromosome 19 (that encompasses, for example, MAN2B1, ZNF443, ZNF44, CRX, GLTSCR2, and GLTSCR1)) are characteristic molecular features of certain types of solid tumors of the central nervous system.

Accordingly, in some embodiments, the present invention provides “break apart” probe sets. In some embodiments, the break apart probe sets comprise a first probe that hybridizes to one side a known breakpoint for a chromosomal translocation and a second probe that hybridizes to the other side of the known breakpoint. Different chromogenic detection reagents are utilized for each of the probes of the break apart probe set so that translocations can be detected. Examples of break apart probe sets include, but are not limited, to sets for mucosa associated lymphoid tissue (MALT), anaplastic lymphoid kinase (ALK), ETS-related gene (ERG) and androgen related rearrangement partners like TMPRSS2 (androgen regulated prostate specific serine 2 protease) suggestive of prostate cancer.

The aforementioned examples are provided solely for purpose of illustration and are not intended to be limiting. Numerous other cytogenetic abnormalities that correlate with neoplastic transformation and/or growth are known to those of skill in the art. Target nucleic acid sequences (e.g., genomic target nucleic acid sequences), which have been correlated with neoplastic transformation and which are useful in the disclosed methods and for which disclosed probes can be prepared, also include the EGFR gene (7p12; e.g., GENBANK™ Accession No. NC_{—}000007, nucleotides 55054219-55242525), the C-MYC gene (8q24.21; e.g., GENBANK™ Accession No. NC_{—}000008, nucleotides 128817498-128822856), D5S271 (5p15.2), lipoprotein lipase (LPL) gene (8p22; e.g., GENBANK™ Accession No. NC_{—}000008, nucleotides 19841058-19869049), RB1 (13q14; e.g., GENBANK™ Accession No. NC_{—}000013, nucleotides 47775912-47954023), p53 (17p13.1; e.g., GENBANK™ Accession No. NC_{—}000017, complement, nucleotides 7512464-7531642)), N-MYC (2p24; e.g., GENBANK™ Accession No. NC_{—}000002, complement, nucleotides 151835231-151854620), CHOP (12q13; e.g., GENBANK™ Accession No. NC_{—}000012, complement, nucleotides 56196638-56200567), FUS (16p11.2; e.g., GENBANK™ Accession No. NC_{—}000016, nucleotides 31098954-31110601), FKHR (13p14; e.g., GENBANK™ Accession No. NC_{—}000013, complement, nucleotides 40027817-40138734), as well as, for example: ALK (2p23; e.g., GENBANK™ Accession No. NC_{—}000002, complement, nucleotides 29269144-29997936), Ig heavy chain, CCND1 (11q13; e.g., GENBANK™ Accession No. NC_{—}000011, nucleotides 69165054 . . . 69178423), BCL2 (18q21.3; e.g., GENBANK™ Accession No. NC_{—}000018, complement, nucleotides 58941559-59137593), BCL6 (3q27; e.g., GENBANK™ Accession No. NC_{—}000003, complement, nucleotides 188921859-188946169), MALF1, AP1 (1p32-p31; e.g., GENBANK™ Accession No. NC_{—}000001, complement, nucleotides 59019051-59022373), TOP2A (17q21-q22; e.g., GENBANK™ Accession No. NC_{—}000017, complement, nucleotides 35798321-35827695), TMPRSS (21q22.3; e.g., GENBANK™ Accession No. NC_{—}000021, complement, nucleotides 41758351-41801948), ERG (21q22.3; e.g., GENBANK™ Accession No. NC_{—}000021, complement, nucleotides 38675671-38955488); ETV1 (7p21.3; e.g., GENBANK™ Accession No. NC_{—}000007, complement, nucleotides 13897379-13995289), EWS (22q12.2; e.g., GENBANK™ Accession No. NC_{—}000022, nucleotides 27994271-28026505); FLI1 (11q24.1-q24.3; e.g., GENBANK™ Accession No. NC_{—}000011, nucleotides 128069199-128187521), PAX3 (2q35-q37; e.g., GENBANK™ Accession No. NC_{—}000002, complement, nucleotides 222772851-222871944), PAX7 (1p36.2-p36.12; e.g., GENBANK™ Accession No. NC_{—}000001, nucleotides 18830087-18935219, PTEN (10q23.3; e.g., GENBANK™ Accession No. NC_{—}000010, nucleotides 89613175-89716382), AKT2 (19q13.1-q13.2; e.g., GENBANK™ Accession No. NC_{—}000019, complement, nucleotides 45431556-45483036), MYCL1 (1p34.2; e.g., GENBANK™ Accession No. NC_{—}000001, complement, nucleotides 40133685-40140274), REL (2p13-p12; e.g., GENBANK™ Accession No. NC_{—}000002, nucleotides 60962256-61003682) and CSF1R (5q33-q35; e.g., GENBANK™ Accession No. NC_{—}000005, complement, nucleotides 149413051-149473128). A disclosed target nucleic acid probe or method may include a region of the respective human chromosome containing at least any one (or more, as applicable) of the foregoing genes. For example, the target nucleic acid sequence for some disclosed probes or methods includes any one of the foregoing genes and sufficient additional contiguous genomic sequence (whether 5′ of the gene, 3′ of the gene, or a combination thereof) for a total of at least 100,000 base pairs (such as at least 250,000, or at least 500,000 base pairs) or a total of between 100,000 and 500,000 base pairs.

In certain embodiments, the probe specific for the target nucleic acid molecule is assayed (in the same or a different but analogous sample) in combination with a second probe that provides an indication of chromosome number, such as a chromosome specific (e.g., centromere) probe. For example, a probe specific for a region of chromosome 17 containing at least the HER2 gene (a HER2 probe) can be used in combination with a chromosome 17 (CEP 17) probe that hybridizes to the alpha satellite DNA located at the centromere of chromosome 17 (17p11.1-q11.1). Inclusion of the CEP 17 probe allows for the relative copy number of the HER2 gene to be determined. For example, normal samples will have a HER2/CEP17 ratio of less than 2, whereas samples in which the HER2 gene is reduplicated will have a HER2/CEP17 ratio of greater than 2.0. Similarly, CEP centromere probes corresponding to the location of any other selected genomic target sequence can also be used in combination with a probe for a unique target on the same (or a different) chromosome.

In other examples, a target nucleic acid sequence (e.g., genomic target nucleic acid sequence) is selected from a virus or other microorganism associated with a disease or condition. Detection of the virus- or microorganism-derived target nucleic acid sequence (e.g., genomic target nucleic acid sequence) in a cell or tissue sample is indicative of the presence of the organism. For example, the probe can be selected from the genome of an oncogenic or pathogenic virus, a bacterium or an intracellular parasite (such as Plasmodium falciparum and other Plasmodium species, Leishmania (sp.), Cryptosporidium parvum, Entamoeba histolytica, and Giardia lamblia, as well as Toxoplasma, Eimeria, Theileria, and Babesia species).

In some examples, the target nucleic acid sequence (e.g., genomic target nucleic acid sequence) is a viral genome. Exemplary viruses and corresponding genomic sequences (GENBANK™ RefSeq Accession No. in parentheses) include human adenovirus A (NC_{—}001460), human adenovirus B (NC_{—}004001), human adenovirus C(NC_{—}001405), human adenovirus D (NC_{—}002067), human adenovirus E (NC_{—}003266), human adenovirus F (NC_{—}001454), human astrovirus (NC_{—}001943), human BK polyomavirus (V01109; GI:60851) human bocavirus (NC_{—}007455), human coronavirus 229E (NC_{—}002645), human coronavirus HKU1 (NC_{—}006577), human coronavirus NL63 (NC_{—}005831), human coronavirus OC43 (NC_{—}005147), human enterovirus A (NC_{—}001612), human enterovirus B (NC_{—}001472), human enterovirus C(NC_{—}001428), human enterovirus D (NC_{—}001430), human erythrovirus V9 (NC_{—}004295), human foamy virus (NC_{—}001736), human herpesvirus 1 (Herpes simplex virus type 1) (NC_{—}001806), human herpesvirus 2 (Herpes simplex virus type 2) (NC_{—}001798), human herpesvirus 3 (Varicella zoster virus) (NC_{—}001348), human herpesvirus 4 type 1 (Epstein-Barr virus type 1) (NC_{—}007605), human herpesvirus 4 type 2 (Epstein-Barr virus type 2) (NC_{—}009334), human herpesvirus 5 strain AD169 (NC_{—}001347), human herpesvirus 5 strain Merlin Strain (NC_{—}006273), human herpesvirus 6A (NC_{—}001664), human herpesvirus 6B (NC_{—}000898), human herpesvirus 7 (NC_{—}001716), human herpesvirus 8 type M (NC_{—}003409), human herpesvirus 8 type P (NC_{—}009333), human immunodeficiency virus 1 (NC 001802), human immunodeficiency virus 2 (NC_{—}001722), human metapneumovirus (NC_{—}004148), human papillomavirus-1 (NC_{—}001356), human papillomavirus-18 (NC._{—}001357), human papillomavirus-2 (NC_{—}001352), human papillomavirus-54 (NC_{—}001676), human papillomavirus-61 (NC_{—}001694), human papillomavirus-cand90 (NC_{—}004104), human papillomavirus RTRX7 (NC_{—}004761), human papillomavirus type 10 (NC_{—}001576), human papillomavirus type 101 (NC_{—}008189), human papillomavirus type 103 (NC 008188), human papillomavirus type 107 (NC_{—}009239), human papillomavirus type 16 (NC_{—}001526), human papillomavirus type 24 (NC_{—}001683), human papillomavirus type 26 (NC_{—}001583), human papillomavirus type 32 (NC_{—}001586), human papillomavirus type 34 (NC_{—}001587), human papillomavirus type 4 (NC_{—}001457), human papillomavirus type 41 (NC_{—}001354), human papillomavirus type 48 (NC₁₃ 001690), human papillomavirus type 49 (NC_{—}001591), human papillomavirus type 5 (NC_{—}001531), human papillomavirus type 50 (NC_{—}001691), human papillomavirus type 53 (NC_{—}001593), human papillomavirus type 60 (NC_{—}001693), human papillomavirus type 63 (NC_{—}001458), human papillomavirus type 6b (NC_{—}001355), human papillomavirus type 7 (NC_{—}001595), human papillomavirus type 71 (NC_{—}002644), human papillomavirus type 9 (NC_{—}001596), human papillomavirus type 92 (NC_{—}004500), human papillomavirus type 96 (NC_{—}005134), human parainfluenza virus 1 (NC_{—}003461), human parainfluenza virus 2 (NC_{—}003443), human parainfluenza virus 3 (NC_{—}001796), human parechovirus (NC_{—}001897), human parvovirus 4 (NC_{—}007018), human parvovirus B19 (NC_{—}000883), human respiratory syncytial virus (NC_{—}001781), human rhinovirus A (NC_{—}001617), human rhinovirus B (NC_{—}001490), human spumaretrovirus (NC_{—}001795), human T-lymphotropic virus 1 (NC_{—}001436), human T-lymphotropic virus 2 (NC_{—}001488).

In certain examples, the target nucleic acid sequence (e.g., genomic target nucleic acid sequence) is from an oncogenic virus, such as Epstein-Barr Virus (EBV) or a Human Papilloma Virus (HPV, e.g., HPV16, HPV18). In other examples, the target nucleic acid sequence (e.g., genomic target nucleic acid sequence) is from a pathogenic virus, such as a Respiratory Syncytial Virus, a Hepatitis Virus (e.g., Hepatitis C Virus), a Coronavirus (e.g., SARS virus), an Adenovirus, a Polyomavirus, a Cytomegalovirus (CMV), or a Herpes Simplex Virus (HSV).

### 4. Processes for Analysis of Samples

In some embodiments, the present invention provides processes for analyzing samples following hybridization and signal processing and detection. These processes are particularly applicable to samples where break-apart probe sets are used to detect gene rearrangement in a sample, for example ALK gene rearrangements. Break-apart probe sets generally comprise at least 5′ and 3′ probe sets directed to target sequence regions that are 5′ and 3′, respectively, to a breakpoint associated with a rearrangement. In some preferred embodiments, the probes are labelled so they may be detected with different colored chromogens, for example blue and red chromogens or with a combination of a chromogen (e.g., a blue or red chromogen) and silver (e.g., with silver ISH). Using ALK rearrangements in non-small-cell lung cancer (NSCLC) as an example, the un-rearranged ALK gene demonstrates a “fused signal” of the red and blue chromogen which is visible as a purple signal or occasionally as slightly separated red and blue signal. When the ALK gene is rearranged, the red and blue signals are split.

Clinical use of ISH results depends on robustness of the process, preferably as determined by sensitivity and specificity over a wide cut-off range, where the cut-off is the percentage of cell within a sample that are scored as having a rearrangement present. The present invention provides a robust test that is easily applied to clinical samples and which is appropriate for automation. In the processes of the present invention, cells within a sample are scored as having a fused signal or an abnormal signal. In preferred embodiments, the presence of any signal other than the fused signal is scored as abnormal. Examples of such abnormal signals include splitting of the signals, loss of the 5′ signal, loss of the 3′ signal, combination of fused and split, etc. This system is greatly simplified as compared to systems where the abnormal signals are classified separately (see e.g., Kwak et al., N Eng J Med 363(18):1693-1703 (2010); Eunhee et al., J. Thor. Onc. 6(3):459-465 (2011). Surprisingly, the processes of the present invention provide 100% specificity and sensitivity over a wide range of cut-off values as compared to RNA and protein expression data from clinical samples.

Multiple ALK inhibitors are being developed as cancer drugs for treating NSCLC with ALK rearrangements. The processes of the present invention are useful for identifying patients that are suitable for treatment with ALK inhibitors. In some embodiments, 5′ and 3′ ALK break-apart probes are hybridized to a patient sample and detected, for example, with chromogenic detection systems that produce one color for the 5′ probe and one color for the 3′ probe. As indicated above, the samples are analyzed and cells within the sample are scored as having a normal fused signal or an abnormal signal, where the abnormal signal is any signal other than the normal fused signal. Samples with abnormal signals falling in a cut-off range selected from the group consisting of from about 15% to 75%, 20% to 60%, 25% to 45% and 27% to 38% of cells with an abnormal signal in the sample are scored as positive for ALK rearrangement. In some embodiments, the patients from which the positive sample is taken are identified as candidates for treatment with an ALK inhibitor. In some embodiments, an ALK inhibitor is administered to the patient.

### EXPERIMENTAL

### Example 1

This example provides data relating to the time required to denature alkaline phosphatase following a first chromogenic detection reaction.

Blocker Incubation Time (minutes)

| | 0 | 8 | 12 | 16 | 20 | 24 |
|---|---|---|---|---|---|---|
| 1^{st} Detection | + | + | +/− | +/− | − | − |
| Preservation (DIG)* | | | | | | |
| 2^{nd} Detection (DNP)** | + | + | + | + | + | + |

*Anti-DIG antibody + Anti-mouse AP antibody + Blocking + Red detection
**Blocking + Anti-DNP antibody + Anti-rabbit AP antibody + Red detection

### Example 2

This example provides data from several different dual color CISH protocols. The data demonstrates that the blue chromogenic precipitate remains after the blocking step (See Protocol 2 compared to Protocol 1), as such the added blocking step at 37 C does not adversely affect the color deposit from the first detection system. Both blue and red ISH signals are distinctly produced (See Protocol 7 compared to Protocol 6) when a blocking step is used, with probes in close proximity yielding a combined color of purple.

| | Protocol | | | | | | |
|---|---|---|---|---|---|---|---|
| | 1 | 2 | 3 | 4 | 5 | 6 | 7 |
| Hybridi- | + | + | + | + | + | + | + |
| zation* | | | | | | | |
| Anti-DIG | + | + | + | − | + | + | + |
| antibody | | | | | | | |
| (mouse) | | | | | | | |
| Anti-mouse | + | + | + | − | + | + | + |
| AP | | | | | | | |
| antibody | | | | | | | |
| Blue | + | + | − | − | − | + | + |
| detection | | | | | | | |
| Blocking | − | + | + | + | − | − | + |
| (24 minutes) | | | | | | | |
| Anti-DNP | − | − | − | + | − | + | + |
| antibody | | | | | | | |
| (rabbit) | | | | | | | |
| Anti-rabbit | − | − | − | + | − | + | + |
| AP | | | | | | | |
| antibody | | | | | | | |
| Red | − | − | + | + | + | + | + |
| detection | | | | | | | |
| ISH signal | Blue | Blue | Negative | Red | Red | Purple/ | Blue/ |
| | | | | | | Red | Red/ |
| | | | | | | | Purple |

DIG-labeled 5′ALK probe and DNP-labeled 3′ALK probe co-hybridization

### Example 3

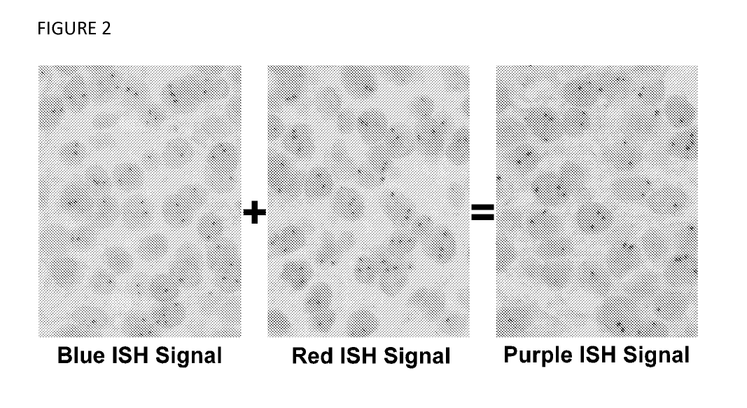

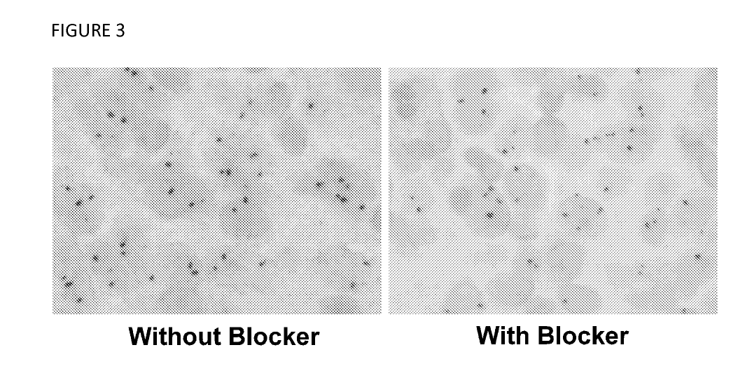

The denaturation step with formamide was used with several probe sets in a two color detection protocol. FIG. 2 provides pictures demonstrating the color scheme (red and blue) for brightfield break-apart in situ hybridization when a block step is not utilized between the two different color detection systems (purple ISH signal throughout). FIG. 3 provides exemplary pictures demonstrating the effect of the blocking step (i.e., treatment with formamide) on AP-based dual color in situ hybridization signals. FIG. 3 further exemplifies that background staining is greatly diminished when blocking is used between color detection systems.

### Materials and Methods

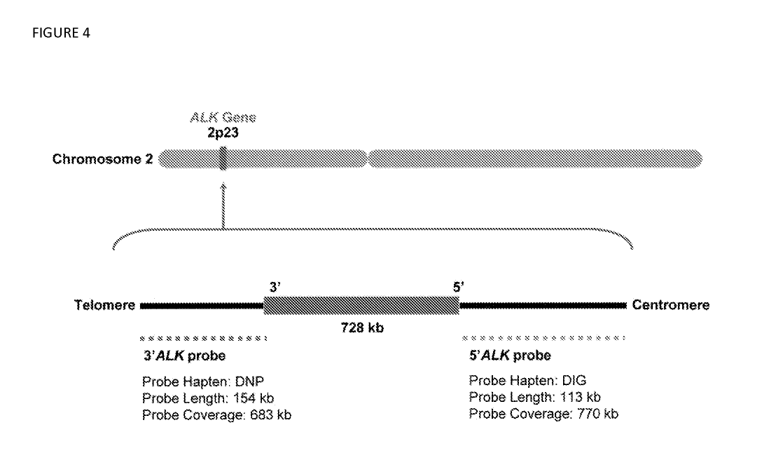

ALK and MALT1 probe design. A break-apart assay was designed to assess the arrangements of the ALK gene loci. Two repeat-free probes were generated to hybridize with the neighboring centromeric region (770 kb) and telomeric regions (683 kb) of the ALK gene (FIG. 4). Bioinformatic tools (Human Genome Browser and Repeat Masker) were used to eliminate repetitive elements. Primer3 program (http://primer3.sourceforge.net) was used to design primers to the unique sequences across the region. The designed PCR fragments and primers were analyzed for similarity to the human genome and transcripts by Human BLAT and Blastnt programs (on the world wide web at genome.ucsc.edu/cgi-bin/hgBlat). Fragments that exhibited high similarity to the other regions were excluded and all PCR fragments were verified by sequencing. The PCR fragments for 5′ ALK probe (total size 113 kb) were ligated, random amplified, and labeled by nick translation using dUTP conjugated to digoxigenin (DIG) (Roche Applied Sciences, Indianapolis, Ind.). Similarly, the 3′ ALK probe (total size 154 kb) were labeled by nick translation using dCTP conjugated to 2,4 dinitrophenyl (DNP) (Ventana Medical Systems, Inc. Tucson, Ariz.).

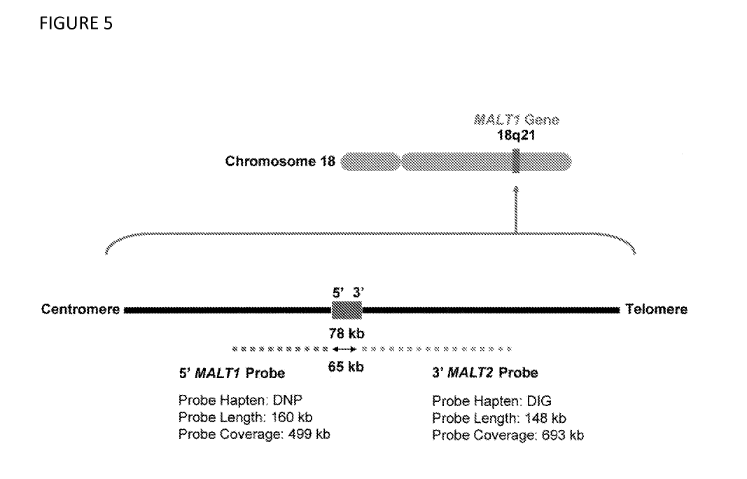

By applying the same technology, the MALT1 break-apart probes were designed to cover ˜500 kb centromeric region (target sequences for 5′ MALT1 probe) and 693 kb telomeric region (target sequences for 3′ MALT1 probe) that flank the known breakpoint region of MALT1 gene (FIG. 5). The repeat-depleted 5′ MALT1 probe (total size 160 kb) was labeled with DNP and the 3′ MALT1 probe (total size 148 kb) with DIG, respectively.

ALK and MALT1 probe specificity test. 5′ and 3′ ALK DNA probe seeds were individually labeled with SpectrumGreen dUTP using the Vysis Nick Translation Kit (Abbott Molecular Inc., Des Plaines, Ill.), purified using the NucAway Spin Columns (Ambion, Austin, Tex.), and formulated at the same stringency as the 5′ DIG-labeled ALK probe and 3′ DNP-labeled ALK probes. To assess the co-localization of the 5′ ALK SpectrumGreen-labeled probe (5′ ALK green probe) and/or 3′ ALK SpectrumGreen-labeled probe (3′ ALK green probe) with Vysis CEP2 SpectrumOrange-labeled probe (CEP2 orange probe) (Abbott Molecular Inc., Des Plaines, Ill.), equal volume of CEP2 orange probe and 5′ ALK green probe (or 3′ ALK green probe) were applied to the comparative genomic hybridization metaphase control slide (Abbott Molecular Inc., Des Plaines, Ill.) after alcohol dehydration. Target metaphase and probe were co-denatured at 84° C. and hybridized overnight at 42° C. in a sealed and humidified chamber (StatSpin, Inc., Westwood, Mass.). The stringency wash was conducted with 2×SSC at 72° C. for 2 minutes and coversliped with DAPI II (Abbott Molecular Inc.) after air drying. Similar to the ALK probes, 5′ and 3′ MALT1 DNA probe seeds were individually labeled with SpectrumGreen dUTP, and assessed their co-localization to Vysis CEP 18 SpectrumOrange (Abbott Molecular Inc.) probes, in the same way as for the ALK probes. Photographs were taken using SPOT CCD microscope digital camera (Diagnostic Instruments, Inc., Sterling Heighs, Mich.) using Zeiss Axioskop fluorescence microscope (Carl Zeiss Microlmaging, Inc., Thornwood, N.Y.) equipped with appropriate filters.

Control and test clinical tissue samples. Routinely processed, formalin-fixed, paraffin-embedded tonsil samples were used as a negative control for visualizing the co-localized 5′ and 3′ ALK or MALT1 probe set. Archived ALCL and MALT lymphoma cases were analyzed for the performance test of ALK or MALT1 ba-ISH assay, respectively. Tissue blocks were cut at 4 μm and placed onto charged glass slides.

Automated brightfield break-apart in situ hybridization protocol. All optimization and performance evaluation for brightfield in situ hybridization ALK and MALT1 gene break-apart assays was conducted with the BenchMark® XT automated slide processing system (Ventana Medical Systems, Inc., Tucson, Ariz., United States). The ba-ISH instrument software was created so that all steps from baking to counterstaining could be conducted without interruption. The slides were baked on the instrument at 65° C. for 20 minutes followed by Liquid Coverslip™ (Ventana) primed EZ Prep™ (Ventana) deparaffinization step. DNA targets were retrieved by the combination of heat-treatment with 1× Reaction Buffer (Tris-based pH 7.6 buffer, Ventana) and tissue digestion with ISH Protease 2 or ISH protease 3 (Ventana). The cocktail of 5′ and 3′ ALK or MALT probes (15 μg/ml each) was formulated with human placental DNA (2 mg/ml) in the Ventana hybridization buffer. The probes and target DNA were co-denatured at 85° C. for 20 minutes and hybridization was conducted at 44° C. for 5 hours. Stringency wash steps were conducted at 72° C. with 233 SSC (Ventana). For both ALK and MALT ba-ISH applications, the sequence of ISH signal detection was performed with blue detection followed by with red detection (FIG. 1). DIG hapten was labeled with mouse anti-DIG antibody, the DIG antibody was reacted with AP-conjugated goat anti-mouse antibody, and AP enzyme was colored with a fast blue. Then, the AP enzyme was denatured with the hybridization buffer for 30 minutes. After washing the slides with 2×SSC, the second ISH detection was performed. DNP hapten was labeled with rabbit anti-DNP antibody, the DNP antibody was reacted with AP-conjugated goat anti-rabbit antibody, and AP enzyme was colored with a fast red detection. All slides were counterstained with Hematoxylin II (Ventana) and Bluing Reagent (Ventana). Counterstained slides were rinsed with distilled water containing DAWN® (Proctor & Gamble Company, Cincinnati, Ohio) for cleaning the slides. Finally, air-dried slides were coverslipped with Tissue-Tek® film coverslipper (Sakura Finetek Japan, Tokyo, Japan). The ba-ISH slides were analyzed and photographed with a Nikon ECLPSE 90i microscope (Nikon Instruments Inc., Melville, N.Y.) equipped with a Nikon digital camera DS-Fil (Nikon).

### Results and Analysis

### ALK and MALT Probe Specificity

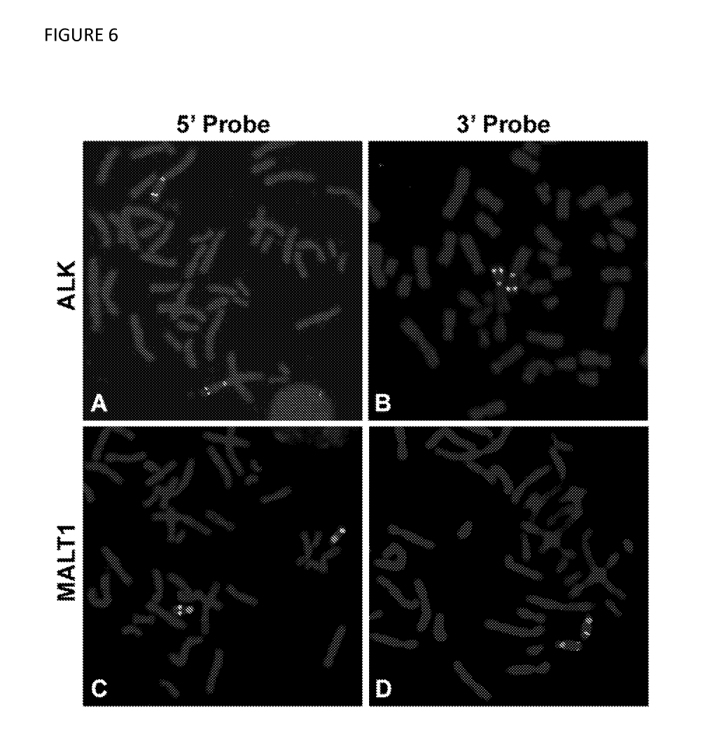

5′ and 3′ALK DNA probes localize to chromosome 2. Simultaneous hybridization of 5′ or 3′ ALK DNA probes nick-translated with SpectrumGreen (5′ ALK green probe and 3′ ALK green probe) and Vysis CEP 2 SpectrumOrange (CEP 2 orange probe) were performed on normal lymphocyte metaphase spreads (FIGS. 6A and B). 5′ ALK green probe and Vysis CEP 2 orange probe were localized to the same chromosome and 5′ ALK probe was detected on the short (p) arms of the chromosome 2 as expected (FIG. 6A). 3′ ALK green probe and Vysis CEP 2 orange probe were also localized to the same chromosome and 3′ ALK probe hybridized to the short (p) arms of the chromosome 2 (FIG. 6B). No cross-hybridization of either 5′ ALK green probe or 3′ ALK green probe to other chromosomes was observed. Thus, 5′ and 3′ ALK probes demonstrated independently the specificity to the target sequences on normal lymphocyte metaphase spreads.

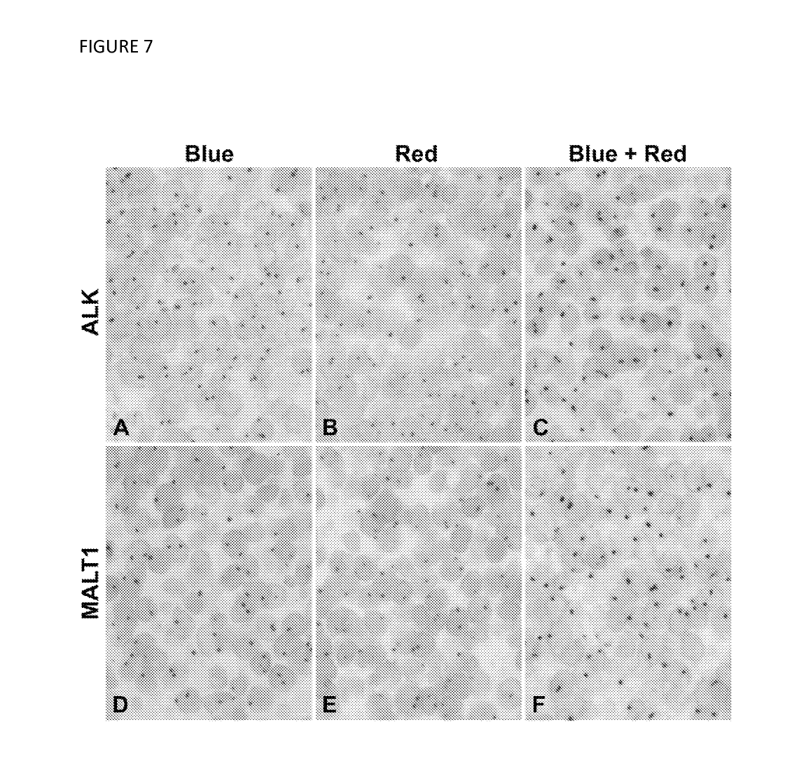

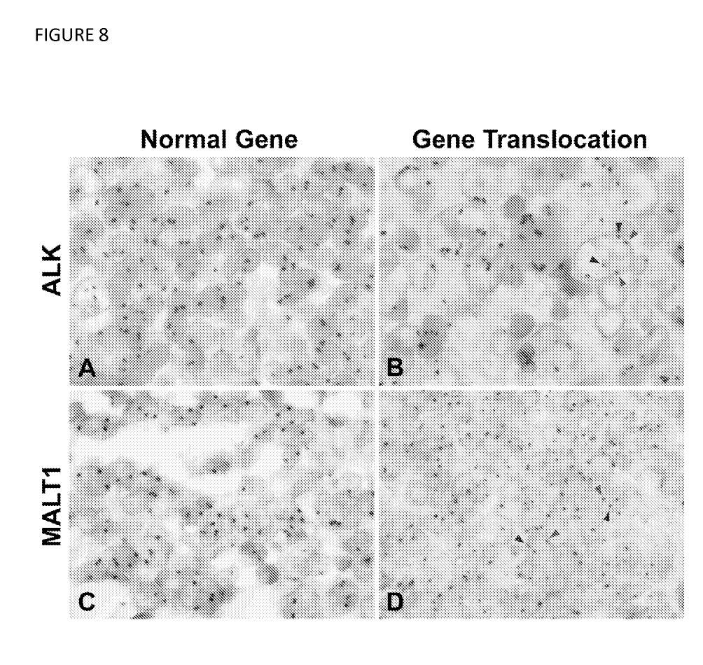

5′ and 3′ MALT1 DNA probes localize to chromosome 18. Hybridization of 5′ and 3′ MALT1 DNA probes nick translated with SpectrumGreen (5′ MALT1 green probe and 3′ MALT1 green probe) and Vysis CEP 18 SpectrumOrange (CEP 18 orange probe) were performed on normal lymphocyte metaphase spreads (FIGS. 7C and D). 5′ MALT1 green probe and Vysis CEP 18 orange probe were localized to the long (q) arms of the chromosome18 (FIG. 6C). 3′ MALT1 green probe and Vysis CEP 18 orange probe were also shown to reside on the long (q) arms of the chromosome 18 (FIG. 6D). No cross-hybridization of the either 5′ MALT1 green probe or 3′ MALT1 green probe to other chromosomes was observed. 5′ MALT1 and 3′ MALT1 probes demonstrated the specificity to the target sequences on the chromosome 18.

### ALK and MALT] Brightfield Break-Apart ISH Performance

Normal ALK and MALT1 gene in tonsil. Blue detection for 5′ ALK probe (FIG. 8A) and red detection of 3′ ALK probe (FIG. 7B) were conducted separately for confirming the performance of each probe on formalin-fixed, paraffin-embedded tonsil sections. Because 1-2 blue or red dots were observed in the nuclei of normal tonsil cells, we confirmed that 5′ ALK and 3′ ALK probes were hybridized to the DNA targets correctly and adequate sensitivity for each target using AP-based ISH detection was achieved. When ALK ba-ISH was performed on normal tonsil sections, 5′ ALK probe and 3′ ALK probe were co-localized and produced overlapping blue and red dots visible as purple dots (FIG. 7C). Thus, this observation further confirmed that both 5′ and 3′ ALK probes were successfully hybridized to the target DNA sequences. It should be noted that there were some cells showing only blue or red dots in normal tonsil cells. Unlike ISH assays on whole cells, in DNA ISH on tissue sections the majority of cells are only partially represented within a tissue section. Blue detection for 3′ MALT1 probe (FIG. 7D) and red detection for 5′ MALT1 probe (FIG. 8E) were also conducted separately for testing the assay performance of each probe on normal tonsil sections. As seen with the ALK probes, there were 1-2 blue or red MALT1 ISH signals in the nuclei of normal tonsil cells. Thus, we confirmed that 5′ and 3′ MALT1 probes recognized the correct target sequences with the automated ISH protocol and the sensitivity for each MALT1 probe hybridization site was sufficient. When 3′ MALT1 and 5′ MALT1 probes were tested together in ba-ISH, the assay produced the purple dot signals as a result of overlapping blue and red colors on tonsil sections (FIG. 8F). As in the ALK ba-ISH assay, there were normal tonsil cells that contained only blue or red ISH signals. As mentioned above, this phenomenon is due to partial cells in sliced tissue sections. This is also an issue in FISH based fusion-signal and break-apart/split-signal assays (Van Dongen et al. 2005). There will always be a background of “false-positivists” and “false-negativities” with fusion-signal ISH and break-apart ISH assays. Combinations of AP-based signals have been multiplexed in immunohistochemical applications by using various blocking methods (van der Loos and Teeling, 2008; Paterson et al, 2008; Pirici et al, 2009) and heat treatment between two IHC assays is effective. However, for brightfield dual color ISH applications with a cocktail of 2 probes, a heat blocking step between 2 AP detections denatures the hybridization between the probe and target. Thus, we needed to find an alternative blocking method. We observed that the hybridization buffer is effective as a blocking/denaturing reagent for the AP enzyme while preserving the specific hybridization between the probe and DNA targets.

Translocated ALK and MALT1 gene in lymphomas. Brightfield ba-ISH for ALK and MALT1 genes was applied to ALK+ ALCL and MALT lymphoma cases, respectively (FIG. 8). Overlapping blue and red ALK ISH signals, seen as purple dots, were observed in normal lymphocytes of formalin-fixed, paraffin-embedded ALK+ ALCL tissue sections (FIG. 8A). Isolated blue and red break-apart ISH signal was seen in ALK+ lymphoma cells while intact ALK genes were visible with overlapping blue and red signals within the same cells (FIG. 8B). Thus, ALK translocations clearly demonstrated with an automated brightfield ba-ISH application using a light microscope and correlate with the tissue morphology and ISH signal. As observed on normal tonsil sections, 5′ and 3′ MALT1 ISH signal was seen as purple dots in the nuclei of normal lymphocytes of MALT lymphoma cases (FIG. 8C). However, separate 5′ and 3′ MALT1 ISH signals were clearly visible as red and blue dots, respectively, as well as overlapping 5′ and 3′ MALT1 ISH signals in MALT lymphoma cells (FIG. 8D). The same ba-ISH application that was used for ALK ba-ISH assay was successfully used for demonstrating MALT1 gene rearrangement without any protocol modifications.

The distance between rearranged 5′ and 3′ ALK or MALT1 regions was not consistent and it is dependent on the spreading of the breakpoints of the gene. Because it appears that not all lymphoma cells of each case show the same gene relocation patterns, it can be speculated that the gene rearrangement in lymphomas is a random event or the heterogeneity of lymphoma cells exists. The size of lymphoma cells between ALK+ ALCL and MALT lymphomas was significantly different. Larger cells have more chances to have truncation artifacts “false-positivity” of break-apart ISH signal from sectioning. Therefore, when ba-ISH slides are read, one must carefully consider if one single color ISH signal is due to: 1) truncation artifacts, 2) gene deletion, or 3) gene translocation. Simple scoring methods must be developed so that a high concordance rate of break-apart ISH slide scoring among pathologists can be achieved. Also further analyses of the distance between two single color ISH signals is required for accurate gene break-apart status to specific diseases.

### Example 4

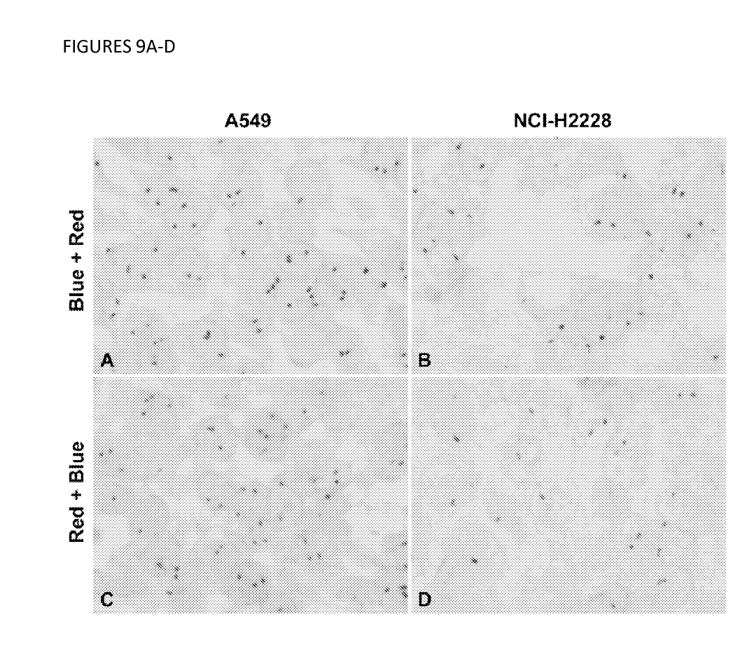

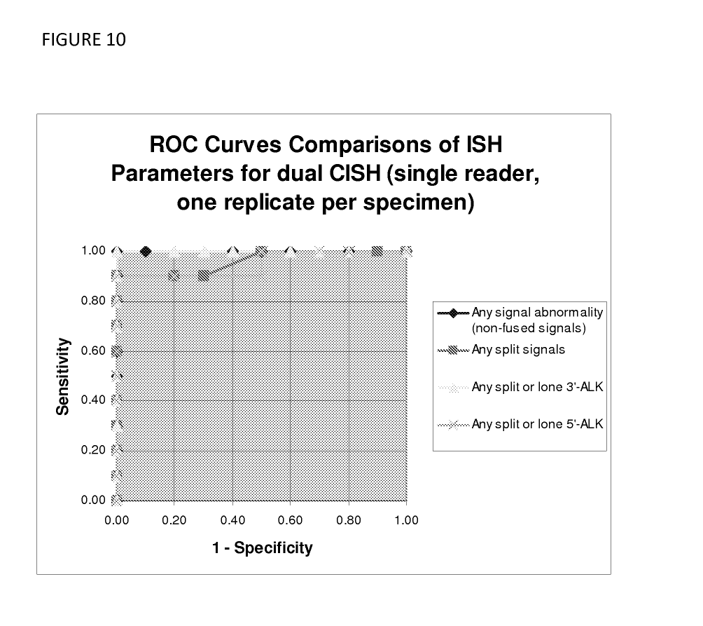

The procedures in Example 2 were repeated, except that red detection was performed first and followed by blue detection. The results are provided in FIG. 9.

### Example 5

The procedures in Example 2 were repeated, except that SDS was used for denaturation between the blue and red detection steps. The results, which are not shown, were unsatisfactory.

### Example 6

This example describes the evaluation of dual CISH and SISH/CISH in situ hybridizations on fixed and embedded lung tumor tissues from patients with NSCLC using a pair of probes hybridizing to 5′- and 3′-regions of the ALK locus. The probes are used to detect the ALK gene rearrangement that leads to increased expression of ALK and indicates a high probability of responding to ALK inhibitor therapy. Dual CISH (blue-red) and SISH/CISH (black-red) were performed on tissue microarrays containing 20 lung tumor tissues in replicate, 10 of which were predetermined to be positive for ALK expression and 10 predetermined to be negative for ALK expression by IHC and reverse transcriptase PCR (RT-PCR). The resulting stained specimens were evaluated under brightfield conditions, enumerating 50 cells per specimen for the number and relative positioning of the 5′- and 3′-ALK signals. The arrays stained with dual CISH were first enumerated by a single reader, evaluating one tissue specimen per replicate, and the following ISH parameters were determined:
P1. Percent cells with only fused 5′- and 3′-ALK signals.
P2. Percent cells with both fused and split 5′- and 3′-ALK signals.
P3. Percent cells with only split 5′- and 3′-ALK signals.
P4. Percent cells with both fused and 5′- and 3′-ALK signals and lone 5′-signals.

P5. Percent cells with both fused and 5′- and 3′-ALK signals and lone 3′-signals.
P6. Percent cells with only lone 5′-ALK signals.
P7. Percent cells with only lone 3′-ALK signals.
P8. Percent cells with any non-fused 5′- and 3′-ALK signals.
P9. Percent cells with any split 5′- and 3′-ALK signals or lone 3′-signals.
P10. Percent cells with any split 5′- and 3′-ALK signals or lone 5′-signals.
P11. Percent cells with any split 5′- and 3′-ALK signals.

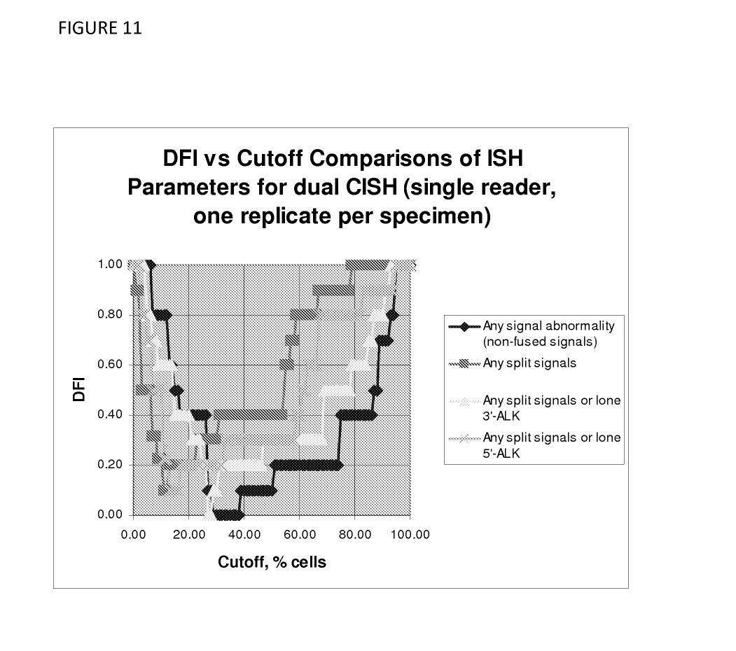

Cutoff values from 0 to 100% cells were applied to each parameter to classify each specimen as positive by ISH (parameter value≧cutoff value), or negative by ISH (parameter value<cutoff value) for the ALK rearrangment. At each cutoff value the sensitivity and specificity were calculated for ALK rearrangement's ability to identify ALK expression as measured by IHC/RT-PCR. Receiver Operator Characteristics (ROC) curves for the 4 best performing parameters are plotted in FIG. 10. The DFI (Distance From Ideal) values, where DFI=((1−sensitivity)+(1−specificity)²)^{1/2}, are plotted versus cutoff value in FIG. 11 for all points on the ROC plots in order to identify the optimal range of cutoff values for each parameter (for a description of DFI see Heselmeyer-Haddad, et al. (2003) Am J Pathol, 163, 1405-1416). From these figures it may be seen that only the percent cells with any non-fused 5′- and 3′-ALK signals (i.e. any split or lone signals), and the percent cells with any split 5′- and 3′-ALK signals or lone 3′-signals provided 100% sensitivity and specificity (DFI=0). From FIG. 11 it may be seen that the former of these two parameters provided the most robust assay as measured by the broadest range of cutoff values that provide the highest levels of sensitivity and specificity. For the former parameter, cutoffs between 27 to 38% cells provided perfect performance (100% sensitivity and specificity, DFI=0), while very good performance was still found for cutoffs between 27 and 50% cells (DFI<0.1), and between 27 and 74% (DFI<0.2).

The dual CISH and SISH/CISH hybridizations were then enumerated by 4 pathologists, each evaluating both replicates of each specimen, and the number of parameters evaluated were expanded and renamed as follows:
P2: % Cells with any non-Fused signals
P3: % cells with only paired split signals (no fused or unpaired signals)
P4: % Cells with fused AND paired split signals (no unpaired signals)
P5: % Cells with paired split signals with or without fused signals (no unpaired signals)
P6: % Cells with paired split signals regardless of other fused or unpaired signals
P7: % Cells with any unpaired 5′-ALK signal(s)
P8: % Cells with fused signals AND any unpaired 5′-ALK signal(s)
P9: % Cells with any unpaired 3′-ALK signal(s)
P10: % Cells with fused signals AND any unpaired 3′-ALK signal(s)
P11: % Cells with >2 total 5′-ALK signals
P12: % Cells with >2 total 3′-ALK signals
P13: % Cells with >2 fused signals
P14: % Cells with >2 paired split signals
P15: % Cells with >1 unpaired 5′-ALK signal
P16: % Cells with >1 unpaired 3′-ALK signal
P17: % Cells with only paired split signals or unpaired 5′-ALK signal(s) (no fused or lone 3′-ALK signals)
P18: % Cells with fused signal(s) and paired split signals or unpaired 5′ signal(s) (no unpaired 3′ signal(s))
P19: % Cells with any paired split signals or unpaired 5′ signal(s) (no unpaired 3′ signal(s))
P20: % Cells with only paired split signals or unpaired 3′-ALK signal(s) (no fused or lone 5′-ALK signals)
P21: % Cells with fused signal(s) and paired split signals or unpaired 3′ signal(s) (no unpaired 5′ signal(s))
P22: % Cells with any paired split signals or unpaired 3′ signal(s) (no unpaired 5′ signal(s))
P23: ave. total 5-ALK signals/cell
P24: ave. total 3′-ALK signals/cell
P25: ave. fused signals/cell
P26: ave. paired split signals/cell
P27: ave. unpaired 5′-ALK signals/cell
P28: ave. unpaired 3′-ALK signals/cell
P29: ave. non-fused 5′-ALK/cell
P30: ave. non-fused 3′-ALK/cell
P31: ave. paired split+excess 5′- or 3′-ALK per cell

As per the first analyses, ROC curves were constructed using the combined results of the 4 pathologists on both replicates of each specimen. The combined pathologists did not achieve 100% sensitivity and specificity on either the dual CISH or SISH/CISH stained specimens. The areas under the ROC curves (AUC) were calculated for each curve as a measure of best parameter performance, and as found in the initial single reader study, the percent cells with any non-fused 5′- and 3′-ALK signals (P2 in the 4-reader study) provided the best performance (highest AUC value) with AUC=0.833, in the SISH/CISH stained specimens. This parameter again provided a broad minimum in the DFI versus cutoff curve compared to other parameters with best performance found between cutoff values of 45 and 66%. The related parameter of the average number of split 3′- and 5′-ALK signals and unpaired 5′- or 3′-ALK signals per cell (P31 in the 4-reader study) provided nearly as good performance (AUC=0.823) as P2 in the 4-reader study on the SISH/CISH stained specimens. In general, the 4-readers had more difficulty enumerating the dual CISH staining than the single reader. Familiarity with enumerating dual CISH signals may have been a problem for the 4 readers and further training is expected to improve their results.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the field of this invention are intended to be within the scope of the following claims.

1. A process for detection of nucleic acids in a sample comprising:
hybridizing at least first and second nucleic acid probes to first and second target nucleic acids in said sample;
contacting said sample with first chromogenic detection reagents specific for said first nucleic acid probe comprising a first enzyme and a first chromogenic substrate system, wherein said contacting is under conditions such that said first enzyme acts on said first chromogenic substrate system to produce a detectable first chromogen;
denaturing said first enzyme;
contacting said sample with second chromogenic detection reagents specific for said second nucleic acid probe comprising a second enzyme and a second chromogenic substrate system, wherein said contacting is under conditions such that said second enzyme acts on said second chromogenic substrate system to produce a detectable second chromogen; and
detecting said first and second detectable chromogens.

2. The process of claim 1, wherein said denaturing comprises treating said sample with a solution comprising a denaturing agent.

3. The process of claim 2, wherein said denaturing agent is selected from the group consisting of formamide, an alkyl-substituted amide, urea or a urea-based denaturant, thiourea, guanidine hydrochloride, and derivatives thereof.

4. The process of claim 2, wherein said denaturing agent is formamide.

5. The process of claim 1, wherein said first nucleic acid probe comprises a first hapten and said second nucleic acid probe comprises a second hapten.

6. (canceled)

7. The process of claim 1, wherein said first enzyme and second enzyme are the same and said first and second chromogenic substrate systems are selected from the group consisting of systems comprising diaminobenzidine (DAB), 4-nitrophenylphospate (pNPP), naphthol phosphate/Fast Red (and variations thereof such as Fast Red KL/Naphthol AS-TR, naphthol phosphate/fuschin, naphthol phosphate/Fast Blue BB (4-(benzoylamino)-2,5-diethoxybenzenediazotetrachlorozincate), bromochloroindolyl phosphate (BCIP)/naphthol phosphate, BCIP/NBT, BCIP/INT, tetramethylbenzidine (TMB), 2,2′azino-di-[3-ethylbenzothiazoline sulphonate] (ABTS), o-dianisidine, 4-chloronaphthol (4-CN), nitrophenyl-β-D-galactopyranoside (ONPG), o-phenylenediamine (OPD), 5-bromo-4-chloro-3-indolyl-β-galactopyranoside (X-Gal), methylumbelliferyl-β-D-galactopyranoside (MU-Gal), p-nitrophenyl-α-D-galactopyranoside (PNP), 5-bromo-4-chloro-3-indolyl-β-D-glucuronide (X-Gluc), and 3-amino-9-ethyl carbazol (AEC).

8. The process of claim 1, wherein said first enzyme and second enzyme are alkaline phosphatase and said first chromogenic substrate system is one of Fast Blue BB or naphthol phosphate/Fast Red and said second chromogenic substrate system is selected from the other of Fast Blue BB/naphthol phosphate and naphthol phosphate/Fast Red.

9.-12. (canceled)

13. The process of claim 5, wherein said first chromogenic detection reagents comprise a first antibody specific for said first hapten and a second antibody specific for said first antibody, wherein said second antibody is conjugated to said first enzyme.

14. The process of claim 13, wherein said first enzyme and said second enzyme are the same enzyme -i-s selected from the group consisting of horseradish peroxidase, alkaline phosphatase, acid phosphatase, glucose oxidase, β-galactosidase, β-glucuronidase and β-lactamase.

15. The process of claim 13, wherein said second chromogenic detection reagents comprise a third antibody specific for said second hapten and a fourth antibody specific for said third antibody, wherein said fourth antibody is conjugated to said second enzyme.

16. (canceled)

17. The process of claim 1, wherein said first enzyme and said second enzyme is the same enzyme.

18. The process of claim 17, wherein said first enzyme and said second enzyme is alkaline phosphatase.

19.-21. (canceled)

22. A kit comprising:
first chromogenic detection reagents specific for a first nucleic acid probe comprising a first enzyme and a first chromogenic substrate system;
second chromogenic detection reagents specific for a second nucleic acid probe comprising a second enzyme and a second chromogenic substrate system; and
a denaturation reagent.

23. A process for diagnosing a non-small-cell lung cancer in a patient, providing a prognosis for a patient with cancer, predicting the likelihood of recurrence of a cancer in a patient, predicting the predisposition of a patient to a cancer, or an indication that a patient is a candidate from treatment with a therapy, wherein the cancer is associated with an ALK gene rearrangement, comprising:
hybridizing 5′ and 3′ ALK break-apart probes to a patient sample, wherein said 5′ and 3′ ALK break-apart probes are probe sets that hybridize either 5′ or 3′ to a breakpoint associated with ALK rearrangement;
detecting signals associated with hybridization said 5′ and 3′ ALK break-apart probes, said signals being different chromogens for said 5′ and 3′ ALK break-apart probes;
scoring any signal other than a fused, non-rearranged signal as an abnormal signal; and
using said score to diagnose a cancer in said patient, provide a prognosis for said patient, predict the likelihood of recurrence of a cancer in said patient, predict the predisposition of said patient to a cancer, or indicate that the patient is a candidate for a particular therapy.

24.-27. (canceled)

28. The process of claim 23, wherein said different chromogens include a first chromogenic detection reagent specific for said 5′ ALK break-apart probe comprising a first enzyme and a first chromogenic substrate system and a second chromogenic detection reagent specific for said 3′ ALK break-apart probe comprising a second enzyme and a second chromogenic substrate system.

29. The process of claim 28, wherein said first enzyme and said second enzyme are the same enzyme and detecting signals associated with hybridization comprises:
contacting said sample with said first chromogenic detection reagents under conditions such that said first enzyme acts on said first chromogenic substrate system to produce a detectable first chromogen;
denaturing said first enzyme; and
contacting said sample with second chromogenic detection reagents under conditions such that said second enzyme acts on said second chromogenic substrate system to produce a detectable second chromogen.

30.-36. (canceled)

37. The process of claim 23, wherein at least one of said signals is silver.

38. The process of claim 37, wherein the other of said signals is red or blue.

39. The process of claim 23, said scoring further comprises applying a cut-off range selected from the group consisting of from about 15% to 75%, 20% to 60%, 25% to 45% and 27% to 38% of cells with an abnormal signal in said sample, wherein samples within the cut-off range are correlated to a diagnosis of cancer in said patient, a good or poor prognosis for said patient, a prediction of likelihood of recurrence of a cancer in said patient, a prediction of the predisposition of said patient to a cancer, or an indication that said patient is a candidate for a particular therapy.

40. The process of claim 39, wherein said process has a sensitivity and/or specificity selected from the group consisting of greater than 90%, greater than 95%, greater than 99% and 100%, when said cut-off range is applied.

41. The process of claim 39, wherein the Distance From Ideal value for said cut-off range is selected from the group consisting of ≦0.2, ≦0.1, and 0.

42. The process of claim 39, further comprising:
providing a prognosis for said patient based upon whether or not the sample is positive or negative for ALK rearrangement based on said scoring,
providing a diagnosis for said patient based upon whether or not the sample is positive or negative for ALK rearrangement based on said scoring,
providing a prediction of likelihood of recurrence for said patient based upon whether or not the sample is positive or negative for ALK rearrangement based on said scoring,
providing a prediction of predisposition of said patient to a cancer based upon whether or not the sample is positive or negative for ALK rearrangement based on said scoring, or
providing a particular therapy to said patient based upon whether or not the sample is positive or negative for ALK rearrangement based on said scoring.

43.-46. (canceled)

47. The process of claim 23, further comprising applying a cut-off of from about 10% to about 40% of cells with an abnormal signal in said sample, wherein samples exceeding the cut-off are correlated to a diagnosis of cancer in said patient, a good or poor prognosis for said patient, a prediction of likelihood of recurrence of a cancer in said patient, a prediction of the predisposition of said patient to a cancer, or an indication that said patient is a candidate for a particular therapy.
